(19) United States
(12) Patent Application Publication
(10) Pub. No.: US 2006/0114886 A1
(43) Pub. Date: Jun. 1, 2006

(54) Broadcasting system and method

(75) Inventors: Ji-Wuck Jung, Seoul (KR); Young-Seop Han, Suwon-si (KR); Young-Jip Kim, Suwon-si (KR); Byoung-Dai Lee, Seongnam-si (KR); Seung-Mi Kang, Yongin-si (KR); Hyun-Chul Kim, Suwon-si (KR)

Correspondence Address: CHA & REITER, LLC, 210 ROUTE 4 EAST STE 103, PARAMUS, NJ, 07652, US

(73) Assignee: Samsung Electronics Co.; LTD

(21) Appl. No.: 11/271,648

(22) Filed: Nov. 10, 2005

(30) Foreign Application Priority Data
Nov. 30, 2004 (KR) 2004-99446

(51) Int. Cl. H04L 12/66

(52) U.S. Cl. 370/352

(57) ABSTRACT

Disclosed is a broadcasting system and method for transmitting/receiving a broadcast data in a broadcasting system, which reduces an application download period by efficiently utilizing a data broadcasting stream and a return channel for application download when a reception terminal receives a data broadcast. The broadcasting system and method includes a data broadcast reception terminal to receive the broadcast data and a bi-directional broadcasting server to communicate with the data broadcast reception terminal through a return channel: the data broadcast reception terminal receives a data broadcast stream during one broadcast transmission period, and requests the bi-directional broadcasting server to transmit a portion of the data broadcast stream (e.g. section data) through the return channel when the section data of the received data broadcast stream is lost; the bi-directional broadcasting server transmits the section data to the data broadcast reception terminal when a download request is received for the section data from the data broadcast reception terminal; and the data broadcast reception terminal performs modularization using a received lost section data and the previously-received section data to extract application files when receiving the lost section data and displays the extracted application files on a screen.

### CLAIM OF PRIORITY

This application claims the benefit under 35 U.S.C. 119(a) of an application entitled “Broadcasting System And Method For Transmitting/Receiving Broadcast Data,” filed in the Korean Intellectual Property Office on Nov. 30, 2004 and assigned Serial No. 2004-99446, the entire contents of which are incorporated herein by reference.

### BACKGROUND OF THE INVENTION

1. Field of the Invention

The present invention relates to a broadcasting system and method for transmitting/receiving broadcast data, and more particularly to a portable mobile communication terminal, a system and method for transmitting/receiving broadcast data in a two-way data broadcasting system.

2. Description of the Related Art

Recently, broadcasting systems have changed from an analog system, which has been available for more than half a century, to digital systems capable of providing better services. A digital broadcasting system is a general term that refers to all systems for transmitting/receiving a broadcast by means of digital signals.

Currently, there are largely two standards for receiving a digital broadcast. The first is the Digital Video Broadcasting (DVB) scheme adopted in Europe, and the second is the Advanced Television Systems Committee (ATSC) scheme adopted in U.S.A. Korea has adopted the ATSC scheme for terrestrial broadcasting, and the DVB scheme for satellite broadcasting.

Advantageously, the digital broadcasting can simultaneously provide both broadcasting and data as well as providing better video and audio, as compared to with analog broadcasting. The data service provided through digital broadcasting includes an electronic program guide (EPG), electronic games, tele-banking, tele-shopping, electronic newspaper, etc.

A user receiving such a digital broadcasting service can obtain additional information about programs and purchase goods by a simple manipulation while watching a television through the data broadcast. Also, the user can search for interesting information such as weather, share, news, etc., and use banking services at home. In this manner, the user can enjoy active participation of the broadcast. For example, the user can participate in a live quiz program to win a prize by accumulating points in various activities, give an account for a news event, or can voice his or her opinion on a broadcast program.

Various broadcast standards have been introduced by respective countries to provide data broadcasting service. For instance, Europe uses a standard known as Multimedia Home Platform (MHP) to provide data service based on a DVB broadcast. The U.S.A. uses a standard for data broadcast known as Advanced Common Application Platform (ACAP) based on the ATSC. Additionally, an OpenCable Application Platform (OCAP) has now been adopted as a standard for providing data broadcasting service through a cable broadcast.

Hereinafter, a procedure for creating a data broadcasting stream to provide such a broadcasting service will be described.

Generally, in digital broadcasting a video signal is encoded using an encoder based on a Moving Picture Experts Group-2 (MPEG-2) standard. An audio signal is encoded by using an AC-3 encoder. In this case, an elementary stream is first packetized to create a packetized elementary stream (PES) packet. Then the PES packet is transformed into 188-byte transport packet to be transmitted in a series of transport streams. Application information desired for transmission is carried with the transport stream, in which this application information is stored and transmitted in a form of data service table (DST). The application is transmitted as consecutive data sections that are repeated periodically and sequentially through a broadcasting signal. Accordingly, a viewer can receive and view the application at any time.

FIG. 1 illustrates a procedure for decoding an application in a typical data broadcast.

A broadcasting terminal first extracts a DST from a transmitted transport stream. Individual data sections of an elementary stream are broadcasted to read a file required for an application. Download data blocks (DDB) are modularized based on route information provided through a download server initiate (DSI) and a download information indication (DII) of each section. In order to configure a module for extracting an application file, it is necessary to wait a predetermined time period until all of required section data have been received.

Application data carried in a digital broadcast are transmitted sequentially and periodically. This is because it is unknown when a viewer starts to receive a broadcast service. Further, it is difficult to know whether data received by the viewer is downloaded without errors.

It is possible that a session data required for configuration of a module may be lost on account of a transmission/reception error. A broadcast stream carried in a digital broadcast is received repeatedly in a predetermined interval. Therefore, even if it fails to receive a section data, the broadcasting terminal can receive the repeatedly-transmitted section data after waiting for a predetermined time (until the section data is carried in the next transmission period). In such an event, the broadcasting terminal generally has to wait for a time period that is two or three times longer than a section data transmission period in order to completely and normally receive the section data to configure a module.

That is, a viewer must wait for at least one section data transmission period in order to download an application. Further, when a part of the section data is not received during one section data transmission period on account of a transmission/reception error or the like, a viewer must wait once more for one section data transmission period in order to receive the part of the section data having not been received. Currently, since a usual section data transmission period is 30 to 60 seconds, a viewer is generally required to wait for one minute thirty seconds to three minutes in order to download an application having such a transmission period. Additionally, the waiting time period for a viewer to download an application becomes longer as the size of the downloaded application becomes larger.

Recently, data broadcasting systems have been used that enable bi-directional communication, in addition to a function to receive a broadcast application as described above. A return channel enables a bi-directional communication between a broadcasting terminal and a broadcasting server through a network, such as the Internet, by using a TCP/IP protocol or the like. In addition, an application may be downloaded through a return channel by using this bi-directional communication. When application information is received by such a scheme, a viewer can receive only a desired part of application information at a desired time point. This in contrast from when an application is included in a broadcast signal and periodically transmitted. Accordingly, even when experiencing a partial error, it is unnecessary for a viewer to wait long periods.

However, when an application is transmitted using a return channel as described above, the load imposed on a server increases as the number of viewers accessing the server at one time increases. Moreover, in the case of performing data transmission by such a manner, since the load imposed on the server and return channel greatly increases, longer time periods are required for information transmission of the bi-directional communication.

### SUMMARY OF THE INVENTION

Accordingly, the present invention has been made to solve the above-mentioned problems occurring in the prior art. One aspect of the present invention is to provide a broadcasting system and method for reducing an application download period by efficiently utilizing a data broadcasting stream and a return channel for application download when a reception terminal receives a data broadcast.

Another aspect of the present invention is to provide a broadcasting system and method for significantly reducing the load imposed on a broadcasting server and a return channel in a data broadcasting system that provides a data broadcast in a bi-directional communication scheme.

Still another aspect of the present invention is to provide a broadcasting system and method for reducing the information transmission period of the bi-directional communication, when broadcast data is provided in a data broadcasting system that provides a data broadcast in a bi-directional communication scheme.

In accordance with one embodiment of the present invention, a broadcasting system is provided for transmitting/receiving a broadcast data, the system including: a data broadcast reception terminal to receive a data broadcast stream during one broadcast transmission period, request a bi-directional broadcasting server to transmit a portion of the data broadcast stream through a return channel (e.g. when the section data of the received data broadcast stream is lost), perform modularization using a portion of the data broadcast stream (i.e. lost section data) and the data broadcast stream received during the broadcast transmission period (i.e. previously-received section data) to extract application files; and the bi-directional broadcasting server to transmit the portion of the data broadcast stream to the data broadcast reception terminal when a download request for the portion of the data broadcast stream is received from the data broadcast reception terminal. The system can be further enabled to display the extracted application files on a screen

In accordance with another embodiment of the present invention, a method is provided for transmitting/receiving a broadcast data in a broadcasting system that includes a data broadcast reception terminal to receive the broadcast data and a bi-directional broadcasting server to communicate with the data broadcast reception terminal through a return channel, the method comprising the steps of: receiving a data broadcast stream during one broadcast transmission period by the data broadcast reception terminal; requesting the bi-directional broadcasting server to transmit a portion of the data broadcast stream through the return channel (e.g. when a section data of the received data broadcast stream is lost); transmitting the portion of the data broadcast data (i.e. lost section data) from the bi-directional broadcasting server to the data broadcast reception terminal, when the bi-directional broadcasting server receives a download request for the portion of the data broadcast data from the data broadcast reception terminal; and performing modularization using a received portion of the data broadcast stream and the data broadcast stream received during the broadcast transmission period (i.e. previously-received section data) to extract application files. The method can be further enabled for displaying the extracted application files on a screen.

### BRIEF DESCRIPTION OF THE DRAWINGS

The present invention will be more apparent from the following detailed descriptions taken in conjunction with the accompanying drawings, in which:

FIG. 1 is illustrates a procedure for decoding an application in a typical data broadcast;

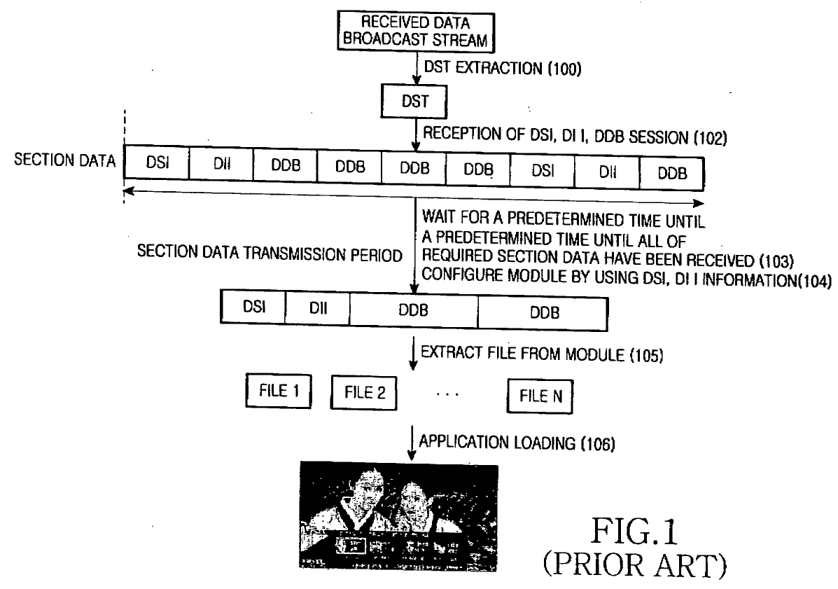

FIG. 2 is a data broadcasting system to which an embodiment of the present invention is applied; and

FIG. 3 is a flowchart explaining a procedure for receiving a data broadcast by the data broadcast reception terminal in the data broadcasting system according to an embodiment of the present invention.

### DETAILED DESCRIPTION

Hereinafter, an embodiment according to the present invention will be described with reference to the accompanying drawings. For the purposes of clarity and simplicity, a detailed description of known functions and configurations incorporated herein will be omitted as it may obscure the subject matter of the present invention.

The data broadcasting system employed in the present invention is a broadcasting system performing bi-directional communication using a return channel.

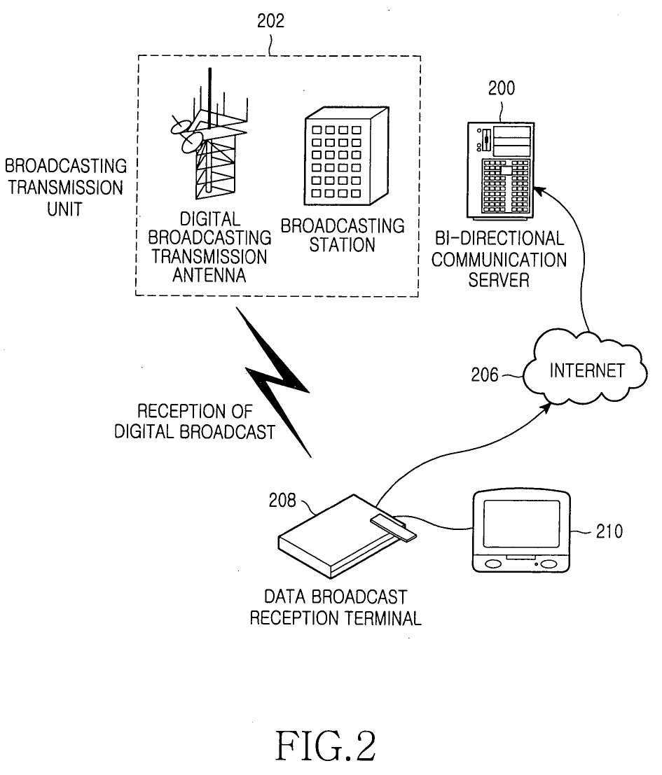

The structure of a data broadcasting system according to the present invention will be described with reference to FIG. 2. FIG. 2 is a data broadcasting system to which an embodiment of the present invention is applied.

The data broadcasting system includes a broadcasting transmission unit 202 for transmitting a digital broadcast signal, a data broadcast reception terminal 208 for receiving the transmitted digital broadcast signal, an external network 206 configured with a return channel used for bi-directional communication, and a broadcasting server 200 for transmitting and receiving information through the return channel.

The data broadcast reception terminal 208 directly downloads an application from a broadcast stream. The data broadcast reception terminal 208 also communicates with the bi-directional broadcasting server 200 through the external network 206, such as the Internet, in order to respond to bi-directional communication. This data broadcast reception terminal 208 includes a network module for a return channel in order to realize the bi-directional communication. This data broadcast reception terminal 208 receives a data broadcast when a viewer either turns on the power supply of the terminal or changes a channel in order to view the data broadcast. In this case, the data broadcast reception terminal 208 receives a section data during one section data transmission period in order to extract a broadcast application. When one section data transmission period elapses, the data broadcast reception terminal 208 checks whether or not there is a lost section data from any of a download server initiate (DSI), a download information indication (DII), and download data blocks (DDB). As a result of the checking, when the data broadcast reception terminal 208 determines that there are no lost section data, the data broadcast reception terminal 208 modularizes the received section data to extract application files. Then it displays the extracted files on a television screen. In contrast, when the data broadcast reception terminal 208 determines that there is a lost section data, the data broadcast reception terminal 208 requests the bi-directional broadcasting server 200 to transmit the lost section data through the return channel. After this, when the data broadcast reception terminal 208 has downloaded the requested section data from the bi-directional broadcasting server 200, the data broadcast reception terminal 208 combines the currently-received section data with the section data previously-received through the existing broadcast signal to extract application files. Then it displays the extracted files on the television screen.

When receiving a download request for the lost section data from the data broadcast reception terminal 208, the bi-directional broadcasting server 200 transmits a lost section data to the data broadcast reception terminal 208. This allows the data broadcast reception terminal 208 to receive only a lost section data as described above.

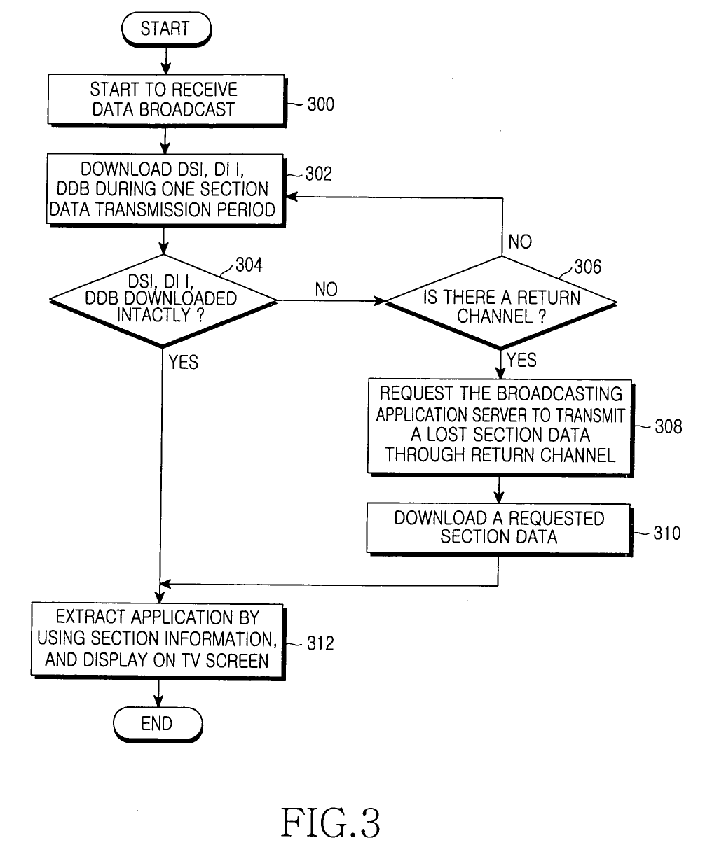

When an application is received as described above, it is possible to greatly reduce the load imposed on the bi-directional broadcasting server and return channel, as compared to when the entire application is received through the return channel. The operation of the data broadcasting system will now be described with reference to FIG. 3.

FIG. 3 is a flowchart explaining a procedure for receiving a data broadcast by the data broadcast reception terminal 208 in the data broadcasting system according to an embodiment of the present invention.

The data broadcast reception terminal 208 starts to receive a data broadcast in step 300. Such data broadcast reception is started when a viewer either turns on the power supply of the terminal or changes a channel in order to view the data broadcast.

In step 302, the data broadcast reception terminal 208 downloads DSI, DII and DDB, which are section data of an application, from a received broadcast signal during one transmission period. Herein, the DSI is a data block which represents an initial position and includes basic information for data. The DII is a data block including an indicator of a download data The DDB is a data block including application information.

In step 304, following step 302, the data broadcast reception terminal 208 checks whether or not the DSI, DII and DDB have been completely downloaded during the one transmission period. That is, the data broadcast reception terminal 208 checks whether or not there is a lost section data.

When the data broadcast reception terminal 208 determines in step 304 that there is no lost section data, the data broadcast reception terminal 208 proceeds to step 312. In step 312, the data broadcast reception terminal 208 modularizes the received section data to extract application files. Then it displays the extracted files on the television screen.

In contrast, when the data broadcast reception terminal 208 determines in step 304 that there is a lost section data, the data broadcast reception terminal 208 proceeds to step 306, which checks whether or not a return channel exists. If a return channel does not exist, the data broadcast reception terminal 208 returns to step 302 to download lost data checked in step 304 from among data transmitted in the next transmission period. In contrast, if the data broadcast reception terminal 208 determines in step 306 that a return channel exists, the data broadcast reception terminal 208 proceeds to step 308. In step 308, the data broadcast reception terminal 208 requests the bi-directional broadcasting server 200 to transmit the section data that had not been received by the terminal 208, through the return channel (i.e., through the internet 206). After this, the data broadcast reception terminal 208 proceeds to step 310 in which the data broadcast reception terminal 208 downloads the required section data from the bi-directional broadcasting server 200, and then proceeds to step 312. That is, the data broadcast reception terminal 208 receives only the lost section data of the section data received during the one section data transmission period.

In step 312, following step 310, the data broadcast reception terminal 208 combines the lost section data with the section data received through the existing broadcast signal to extract application files. Then it displays the extracted files on the television screen.

In this manner, the data broadcast reception terminal downloads an application from a data broadcast during one section data transmission period, and requests the server to transmit a lost section data through a return channel.

Advantageously, the broadcasting system according to the present invention can improve performance thereof by a factor of two, than that of the conventional broadcasting system (when considering that the conventional broadcasting system requires an application download time period, which is two or three times longer than one section data transmission time period). If the amount of lost section data is small when an application has been downloaded during one period, the amount of section data required to be downloaded through a return channel is also small. In this case, it is expected that a load imposed on the broadcasting server and return channel is small. Therefore, it is possible to solve the load problem which may occur when the entire application is downloaded through a return channel.

While the present invention has been shown and described with reference to certain preferred embodiments thereof, it will be understood by those skilled in the art that various changes in form and details may be made therein without departing from the spirit and scope of the invention as defined by the appended claims. Accordingly, the scope of the invention is not to be limited by the above embodiments but by the claims and the equivalents thereof.

What is claimed is:

1. A broadcasting system comprising:
a data broadcast reception terminal to receive a data broadcast stream during a broadcast transmission period, and request a bi-directional broadcasting server to transmit a portion of the data broadcast stream through a return channel, perform modularization using the portion of the data broadcast stream and the data broadcast stream received during the broadcast transmission period to extract application files; and
the bi-directional broadcasting server to transmit the portion of the data broadcast stream to the data broadcast reception terminal when a download request for the portion of the data broadcast stream is received from the data broadcast reception terminal.

2. The system as claimed in claim 1, wherein the data broadcast reception terminal requests the portion of the data broadcast stream to be transmitted when a section data of the received data broadcast stream is lost, not received or has incurred an error during the broadcast transmission period.

3. The system as claimed in claim 2, wherein the data broadcast reception terminal modularizes lost section data in the received portion of the data broadcast stream and section data of the data broadcast stream received during the broadcast transmission period.

4. The system as claimed in claim 1, wherein the data broadcast reception terminal further displaying the extracted application files on a screen

5. The system as claimed in claim 1, wherein the data broadcast reception terminal receives the data broadcast stream during one broadcast transmission period

6. The system as claimed in claim 5, wherein the one broadcast transmission period occurs when a viewer turns on a power supply of the data broadcast reception terminal or changes a channel in order to view a data broadcast.

7. The system as claimed in claim 3, wherein the data broadcast reception terminal modularizes received section data to extract application files when there is no lost section data in the data broadcast stream received during the broadcast transmission period, and displays the extracted application files on a screen.

8. A method for transmitting/receiving broadcast data in a broadcasting system that includes a data broadcast reception terminal and a bi-directional broadcasting server to communicate with the data broadcast reception terminal through a return channel, the method comprising the steps of:
receiving, by the data broadcast reception terminal, a data broadcast stream during one broadcast transmission period;
requesting, by the data broadcast reception terminal, the bi-directional broadcasting server to transmit a portion of the data broadcast stream through the return channel;
transmitting the portion of the data broadcast stream from the bi-directional broadcasting server to the data broadcast reception terminal, when the bi-directional broadcasting server receives a download request for the portion of the data broadcast stream from the data broadcast reception terminal; and
performing modularization using the portion of the data broadcast stream and the data broadcast stream received during the broadcast transmission period to extract application files.

9. The method as claimed in claim 8, wherein the requesting step includes, the data broadcast reception terminal, requesting the portion of the data broadcast stream to be transmitted when a section data of the received data broadcast stream is lost, not received or has incurred an error during the broadcast transmission period.

10. The method as claimed in claim 9, wherein the modularizing step includes modularizing lost section data in the received portion of the data broadcast stream and section data of the data broadcast stream received during the broadcast transmission period.

11. The method as claimed in claim 8, further including the step of displaying the extracted application files on a screen

12. The method as claimed in claim 8, wherein the data broadcast reception terminal receives the data broadcast stream during one broadcast transmission period, when a viewer either turns on a power supply of the data broadcast reception terminal or changes a channel in order to view a data broadcast.

13. The method as claimed in claim 8, further comprising a step of modularizing received section data to extract application files when there is no lost section data in the received data broadcast stream and then displaying the extracted application files on a screen.
